(19) United States
(12) Patent Application Publication
(10) Pub. No.: US 2016/0290212 A1
(43) Pub. Date: Oct. 6, 2016

(54) ATTACHMENT ASSEMBLY FOR HEAT-SHIELD ARRANGEMENT

(71) Applicant: Caterpillar Inc., Peoria, IL (US)

(72) Inventors: Robert A. Sarsfield, Dunlap, IL (US); Fengjuan Zhao, Peoria, IL (US)

(73) Assignee: Caterpillar Inc., Peoria, IL (US)

(21) Appl. No.: 15/182,679

(22) Filed: Jun. 15, 2016

(51) Int. Cl. F01N 13/18; F01N 13/14; F01D 25/08

(52) U.S. Cl. CPC F01N 13/1827; F01D 25/08; F01N 13/14; F05D 2220/40

(57) ABSTRACT

An attachment assembly for coupling a turbocharger heat-shield to an exhaust manifold heat-shield is provided. The turbocharger heat-shield includes a flange portion extending therefrom. The attachment assembly includes a bracket and a coupling mechanism. The bracket defines through holes. The bracket is in contact with the flange portion of the turbocharger heat-shield. The coupling mechanism includes a number of fastening members. The fastening members are received through the through holes of the bracket and corresponding holes of the flange portion and the exhaust manifold heat-shield respectively. Therefore, the coupling mechanism sealably couples the bracket with the flange portion and the exhaust manifold heat-shield.

### TECHNICAL FIELD

The present disclosure relates generally to a heat-shield arrangement for a turbocharger and an exhaust manifold of an engine. More specifically, the present disclosure relates to an attachment assembly for coupling a turbocharger heat-shield to an exhaust manifold heat-shield of the heat-shield arrangement.

### BACKGROUND

Engines, such as internal combustion engines, generally employ a turbocharger and an exhaust manifold for engine operation. The turbocharger is attached to the exhaust manifold to receive engine exhaust gases for turbocharger operation. The exhaust manifold and the turbocharger are heated up due to high temperatures of inflowing exhaust gases. Moreover, various inflatable fluids are used in the engine for different operational purposes. There may be situations when the inflatable fluid may leak within the engine and may drip on either of the turbocharger and the exhaust manifold. However, such dripping and contact of the leaked inflatable fluid with the turbocharger and the exhaust manifold may be unfavorable for the engines.

In order to avoid the contact of the leaked inflatable fluid with the turbocharger and the exhaust manifold, the engine employs a heat-shield arrangement. The heat-shield arrangement includes a turbocharger heat-shield and an exhaust manifold heat-shield. The turbocharger heat-shield and the exhaust manifold heat-shield covers and insulates the turbocharger and the exhaust manifold respectively. Conventionally, the turbocharger heat-shield is made of a three-layered flexible fabric and the exhaust manifold heat-shield is made of a solid metallic insulator material. In conventional engines, the turbocharger heat-shield is attached to the exhaust manifold heat-shield via a spring and hook type attachment assembly

U.S. Pat. No. 7,234,302 (the '302 reference) describes a turbocharger connected to an exhaust manifold via a connection pipe. In the '302 reference, a housing jacket covers and insulates the turbocharger. Both the housing jacket and the connection pipe are made of heat conductive material to reduce heat losses.

However, in known solutions, some inflatable fluid may intrude through an interface between the turbocharger heat-shield and the exhaust manifold heat-shield, which is undesirable. Additionally, the turbocharger heat-shield may be loosely positioned and may displace relative to the exhaust manifold heat-shield. Hence, there is a need to provide an improved attachment assembly for coupling the turbocharger heat-shield to the exhaust manifold heat-shield of the heat-shield arrangement.

### SUMMARY OF THE DISCLOSURE

Various aspects of the present disclosure are directed towards an attachment assembly for coupling a turbocharger heat-shield to an exhaust manifold heat-shield. The turbocharger heat-shield includes a flange portion extending therefrom. The attachment assembly includes a bracket and a coupling mechanism. The bracket defines a plurality of through holes. The bracket is adapted to be in contact with the flange portion of the turbocharger heat-shield. The coupling mechanism is associated with the bracket. The coupling mechanism includes a plurality of fastening members. The fastening members are adapted to be received through the through holes of the bracket and corresponding holes of the flange portion and the exhaust manifold heat-shield respectively. Additionally, the coupling mechanism is adapted to sealably couple the bracket with the flange portion and the exhaust manifold heat-shield.

### BRIEF DESCRIPTION OF THE DRAWINGS

FIG. 1 is a perspective view of a heat-shield arrangement, illustrating a turbocharger heat-shield and an exhaust manifold heat-shield, in accordance with the concepts of the present disclosure;

FIG. 2 is a sectional side view of a portion of the heat-shield arrangement of FIG. 1 taken along a section A-A′ of FIG. 1, illustrating an arrangement of an attachment arrangement with the turbocharger heat-shield and the exhaust manifold heat-shield, in accordance with the concepts of the present disclosure;

FIG. 3 is an exploded view of the attachment arrangement of FIG. 1, in accordance with the concepts of the present disclosure; and

FIG. 4 is a perspective view of the attachment arrangement of FIG. 2, in accordance with the concepts of the present disclosure.

### DETAILED DESCRIPTION

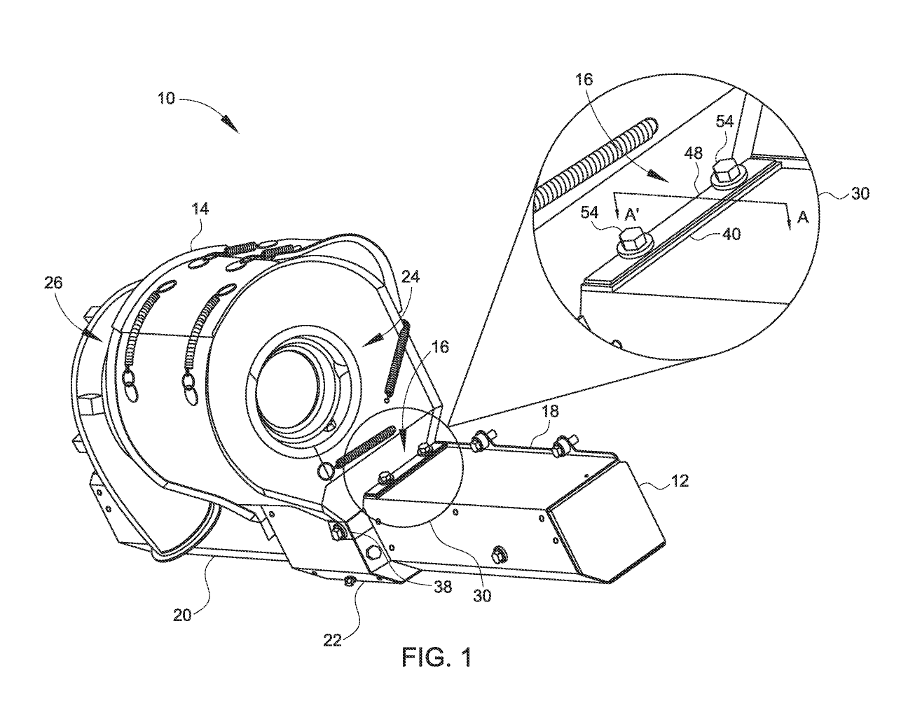

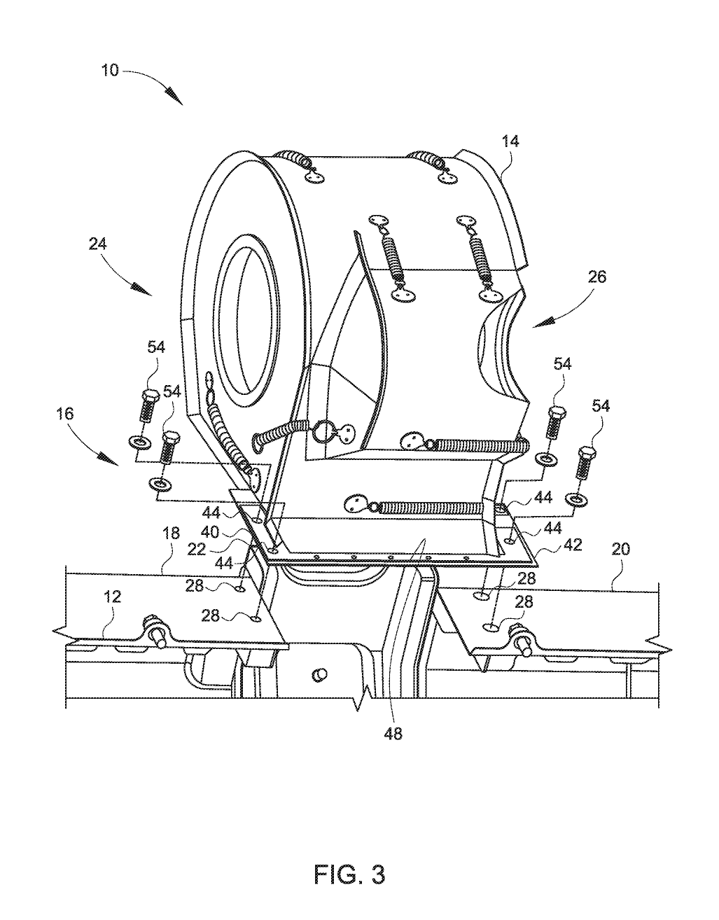

Referring to FIGS. 1 and 3, an exemplary heat-shield arrangement 10, is shown. The heat-shield arrangement 10 is adapted to cover and insulate an exhaust manifold (not shown) and a turbocharger (not shown) of an engine (not shown). The heat-shield arrangement 10 includes an exhaust manifold heat-shield 12, a turbocharger heat-shield 14, and an attachment assembly 16.

The exhaust manifold heat-shield 12 is a rectangular shaped structure made up of fabricated metallic sheets. The exhaust manifold heat-shield 12 is structured and arranged to cover and insulate the exhaust manifold (not shown). Further, the exhaust manifold heat-shield 12 includes a first section 18, a second section 20, and an intermediate section 22. The first section 18 is positioned proximal to a first side 24 of the turbocharger heat-shield 14. The second section 20 is positioned proximal to a second side 26 of the turbocharger heat-shield 14. The intermediate section 22 is disposed between the first section 18 and the second section 20, adjacent to the turbocharger heat-shield 14. Each of the first section 18, the second section 20, and the intermediate section 22 define a multiplicity of holes 28 (see FIG. 3), which facilitate coupling of the exhaust manifold heat-shield 12 to the turbocharger heat-shield 14.

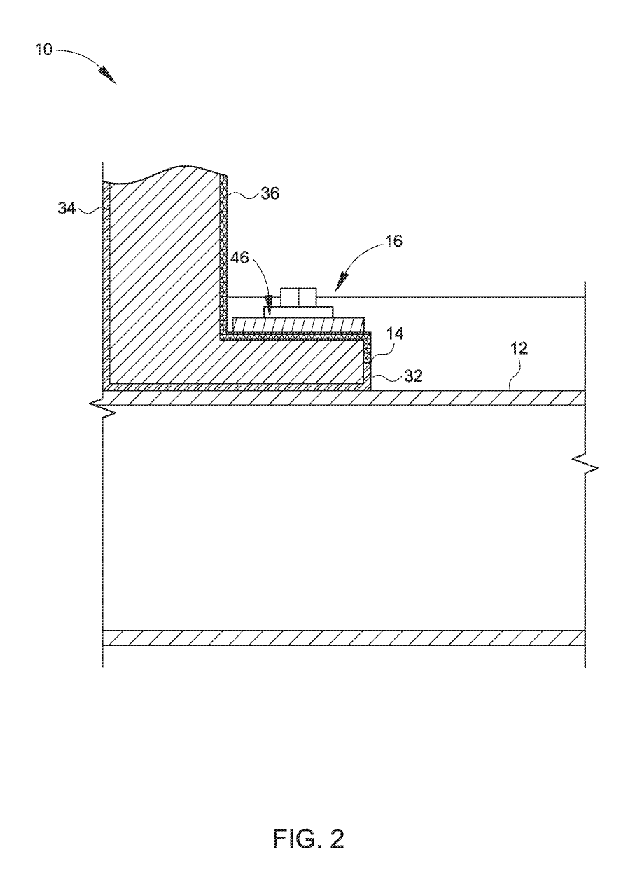

Referring to FIG. 2, a sectional view of a portion 30 of the heat-shield arrangement 10 taken along an axis A-A′, illustrating various layers of the turbocharger heat-shield 14, is shown. The turbocharger heat-shield 14 is made up of a three layered flexible material. More specifically, the turbocharger heat-shield 14 includes an inner layer 32, a middle layer 34, and an outer layer 36. The inner layer 32 is a thin foil of steel material. The middle layer 34 is made of an insulating material. Examples of the insulating material may include, polystyrene, polyisocyanurate, cellulose, and fiberglass. The outer layer 36 is made up of a textile fabric.

Referring back to FIGS. 1 and 3, the turbocharger heat-shield 14 is structured and arranged to cover and insulate the turbocharger (not shown). More specifically, the turbocharger heat-shield 14 is shaped and sized to cover and insulate the turbocharger not shown). The turbocharger heat-shield 14 includes an extension portion 38, a first flange portion 40, and a second flange portion 42 (see FIG. 3). The extension portion 38 is abutted and is coupled to the intermediate section 22 of the exhaust manifold heat-shield 12. The first flange portion 40 is abutted and is coupled to the first section 18 of the exhaust manifold heat-shield 12. The second flange portion 42 (see FIG. 3) is abutted and is coupled to the second section 20 of the exhaust manifold heat-shield 12. Each of the extension portion 38, the first flange portion 40, and the second flange portion 42 (see FIG. 3) define a multiplicity of holes 44 axially aligned with the multiplicity of holes 28 of the first section 18, the second section 20, and the intermediate section 22 respectively.

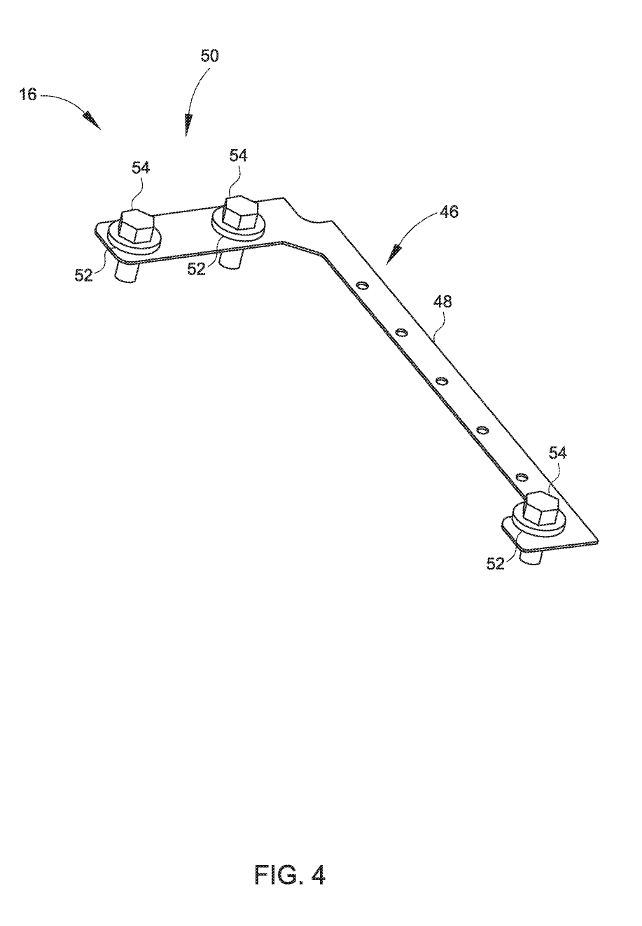

Referring to FIG. 4, there is shown the attachment assembly 16 to seal an interface between the turbocharger heat-shield 14 and the exhaust manifold heat-shield 12. More specifically, the attachment assembly 16 sealably couples the turbocharger heat-shield 14 to the exhaust manifold heat-shield 12. Additionally, the attachment assembly 16 facilitates positive location of the turbocharger heat-shield 14 to the exhaust manifold heat-shield 12. The attachment assembly 16 employs a first set of bracket and coupling mechanism 46.

Referring to FIGS. 2 and 4, the first set of bracket and coupling mechanism 46, is shown. The first set of bracket and coupling mechanism 46 of the attachment assembly 16 sealably couples the first flange portion 40 of the turbocharger heat-shield 14 to the first section 18 of the exhaust manifold heat-shield 12. Additionally, the first set of bracket and coupling mechanism 46 of the attachment assembly 16 sealably couples a portion of the second flange portion 42 of the turbocharger heat-shield 14 to the second section 20 of the exhaust manifold heat-shield 12. Although, the present disclosure describes the attachment assembly 16 to employ the first set of bracket and coupling mechanism 46 to sealably couple the first flange portion 40 to the first section 18 and to couple a portion of the second flange portion 42 to the second section 20, the attachment assembly 16 may also be contemplated to employ various other similar bracket and coupling mechanisms, to sealably couple various other portions of the turbocharger heat-shield 14 to various other sections of the exhaust manifold heat-shield 12. In an exemplary embodiment, the attachment assembly 16 may employ a similar second set of bracket and coupling mechanism (not shown) to sealably couple another portion of the second flange portion 42 of the turbocharger heat-shield 14 to the second section 20 of the exhaust manifold heat-shield 12. Similarly, the attachment assembly 16 may employ a similar third set of bracket and coupling mechanism (not shown) and a similar fourth set of bracket and coupling mechanism (not shown), which in conjunction, sealably couple the extension portion 38 of the turbocharger heat-shield 14 to the intermediate section 22 of the exhaust manifold heat-shield 12. For ease in reference and understanding, structure and arrangement of the first set of bracket and coupling mechanism 46, will be described hereinafter. The first set of bracket and coupling mechanism 46 includes a bracket 48 and a coupling mechanism 50.

The bracket 48 is U-shaped hold down bracket generally made of steel material. The bracket 48 includes a number of through holes 52. The bracket 48 is positioned in abutment with the first flange portion 40 of the turbocharger heat-shield 14, such that one or more through holes 52 are axially aligned with one or more holes 44 of the first flange portion 40 and correspondingly with one or more holes 28 of the first section 18 of the exhaust manifold heat-shield 12. In such arrangement, a portion of the bracket 48 is positioned in abutment with a portion of the second flange portion 42 of the turbocharger heat-shield 14, such that one of the through holes 52 is axially aligned with one of the holes 44 of the second flange portion 42 and correspondingly one of the holes 28 of the second section 20 of the exhaust manifold heat-shield 12. Although, the bracket 48 is described to be a U-shaped hold down bracket made of steel material, however various shapes, materials, and designs of the bracket 48 may also he contemplated. Shape, size, and design of the bracket 48 may vary based on corresponding shape, material, and design of the exhaust manifold heat-shield 12 and the turbocharger heat-shield 14.

The coupling mechanism 50 includes a number of fasteners 54, The fasteners 54 pass through the through holes 52 of the bracket 48 and extend through the corresponding holes 44 of the first flange portion 40 and the corresponding holes 28 of the first section 18. Additionally, one of the fasteners 54 passes through one of the through holes 58 of the bracket 48 and extends through one of the holes 44 of the second flange portion 42 and one of the holes 28 of the second section 20. Therefore, the coupling mechanism 50 of the first set of bracket and coupling mechanism 46 sealably couples the bracket 48 with the first flange portion 40 and a portion of the second flange portion 42. Additionally, the coupling mechanism 50 sealably couples the bracket 48 with the first section 18 and the second section 20 of the exhaust manifold heat-shield 12. Such arrangement of the bracket 48 and the coupling mechanism 50 of the first set of bracket and coupling mechanism 46, facilitates positive location of the turbocharger heat-shield 14 to the exhaust manifold heat-shield 12.

### Industrial Applicability

In operation, the heat-shield arrangement 10 is installed to cover and insulate the turbocharger (not shown) and the exhaust manifold (not shown) of the engine (not shown). More specifically, the exhaust manifold heat-shield 12 is mounted on the engine housing (not shown) to cover and insulate the exhaust manifold (not shown). Additionally, the turbocharger heat-shield 14 covers and insulates the turbocharger (not shown). As the turbocharger heat-shield 14 is made of flexible three layered material, the turbocharger heat-shield 14 is flexible and easily conforms to the shape of the turbocharger (not shown). This increases a service life of the turbocharger heat-shield 14, Further, as the turbocharger heat-shield 14 is positioned on the turbocharger (not shown), the first flange portion 40 abuts with the first section 18, the second flange portion 42 abuts with the second section 20, and the extension portion 38 abuts with the intermediate section 22 of the exhaust manifold heat-shield 12. The turbocharger heat-shield 14 is so positioned that the holes 44 of the first flange portion 40, the second flange portion 42, and the extension portion 38 are axially aligned with the holes 28 of the first section 18, the second section 20, and the intermediate section 22 of the exhaust manifold heat-shield 12.

Furthermore, the attachment assembly 16 sealably couples the turbocharger heat-shield 14 to the exhaust manifold heat-shield 12. For ease in reference and understanding, structure and arrangement of the first set of bracket and coupling mechanism 46 to sealably couple the first flange portion 40 to the first section 18 and a portion of the second flange portion 42 to the second section 20, will be described hereinafter. In an embodiment, the second set of bracket and coupling mechanism (not shown), the third set of bracket and coupling mechanism (not shown), and the fourth set of bracket and coupling mechanism (not shown), may be used in conjunction with the first set of bracket and coupling mechanism 46, to sealably couple the turbocharger heat-shield 14 to the exhaust manifold heat-shield 12.

The first set of bracket and coupling mechanism 46 includes the bracket 48 and the coupling mechanism 50. Initially, the bracket 48 is positioned in abutment with the first flange portion 40 and the portion of the second flange portion 42 of the turbocharger heat-shield 14. The bracket 48 is on positioned that the through holes 52 of the bracket 48 are axially aligned with the holes 44 of the first flange portion 40 and with the hole 44 of the portion of the second flange portion 42. Thereafter, the fasteners 54 are passed through the through holes 52 of the bracket 48 and are extended through the corresponding holes 44 of the first flange portion 40 and the corresponding holes 28 of the first section 18. Additionally, the fastener 54 is passed through the through holes 52 of the bracket 48 and is extended through the hole 44 of the second flange portion 42 and the hole 28 of the second section 20. Therefore, the fasteners 54 of the coupling mechanism 50 sealably couples the bracket 48 to the turbocharger heat-shield 14 and the exhaust manifold heat-shield 12. Such an arrangement of the attachment assembly 16 sealably couples the turbocharger heat-shield 14 to the exhaust manifold heat-shield 12.

In certain situations of leakage of inflatable fluid, the exhaust manifold heat-shield 12 and the turbocharger heat-shield 14 prevent a contact of the inflatable fluid with the exhaust manifold (not shown and the turbocharger (not shown) respectively. As the attachment assembly 16 seals the turbocharger heat-shield 14 to the exhaust manifold heat-shield 12, the attachment assembly 16 restricts fluid intrusion into the heat-shield arrangement 10. Additionally, as the attachment assembly 16 couples the turbocharger heat-shield 14 to the exhaust manifold heat-shield 12, the turbocharger heat-shield 14 is fixedly positioned on the turbocharger (not shown) and may not be easily displaced and dislocated on the exhaust manifold heat-shield 12.

What is claimed is:

1. An attachment assembly for coupling a turbocharger heat-shield to an exhaust manifold heat-shield, the turbocharger heat-shield including a flange portion extending therefrom, the attachment assembly comprising:
a bracket defining a plurality of through holes, wherein the bracket is adapted to be in contact with the flange portion of the turbocharger heat-shield; and
a coupling mechanism associated with the bracket, the coupling mechanism including a plurality of fastening members adapted to be received through the plurality of through holes of the bracket and corresponding holes of the flange portion and the exhaust manifold heat-shield respectively,
wherein the coupling mechanism is adapted to sealably couple the bracket with the flange portion and the exhaust manifold heat-shield.
